(19) United States
(12) Patent Application Publication
(10) Pub. No.: US 2009/0034270 A1
(43) Pub. Date: Feb. 5, 2009

(54) DECORATIVE ORNAMENT FOR RECESSED CAN CEILING LIGHT FIXTURE OR DOME

(76) Inventor: Lori J. Schneider, Zimmerman, MN (US)

Correspondence Address: Lori J. Schneider, 13424-4th Avenue South, Zimmerman, MN, 55398, US

(21) Appl. No.: 12/133,610

(22) Filed: Jun. 5, 2008

Related U.S. Application Data
(60) Provisional application No. 60/933,386, filed on Jun. 6, 2007.

(51) Int. Cl. F21V 7/00; F21V 19/00; F21S 8/06

(52) U.S. Cl. 362/341; 362/382; 362/404

(57) ABSTRACT

A decorative ornament designed for providing a home or office, and more particularly, a decorative ornament for illumination with a light source, which creates an aesthetic addition in a room or space. The ornament is easy to install and remove, inexpensive to manufacture and resistant to heat, such that it may be used near a light source.

### CROSS REFERENCE TO RELATED APPLICATION

This application claims priority to U.S. Provisional Patent Application No. 60/933,386 entitled Decorative Ornament For Recessed Can Ceiling Light Fixture Or Dome filed Jun. 6, 2007, the entire contents of which are hereby incorporated by reference.

### BACKGROUND OF THE INVENTION

This invention relates to a decorative ornamentation for use with a commonly used recessed can ceiling light fixture or semi-flush light fixture, for aesthetic purposes. Consumers like to decorate for holiday seasons and add accents in their homes in unique ways. Consumers also typically wish to decorate the interiors and exteriors of their homes inexpensively and in a manner that will not impart damage to their homes in the process. Hence, having decorations that are cost-effective, temporary (if so desired) and easy to install by the consumer without professional assistance or the need for special installation tools, equipment and/or methods is desirable.

In particular, it is known in the art that consumers use lighting fixtures in their homes and businesses in order to provide aesthetically-pleasing lighting options. For example, U.S. Pat. No. 6,863,423 illustrates a type of light fixture having releasably attachable objects and methods for trimming light fixtures. However, such fixtures are complicated, requiring (at a minimum) knowledge of implementing and managing electrical connections, as well as expert knowledge and special tooling or equipment (i.e., ladder) to effectively place the fixture. Such fixtures, as result, are costly and complicated to use.

U.S. Pat. No. 6,866,940 also illustrates a type of decorative ornament used on or in homes. However, such decorative ornament utilizes mounting blocks and mounted springs as a means of connecting the ornament to (as described therein) the shutter on a house. Again, the installation of such an ornament would be complicated, most likely requiring some degree of knowledge and/or special tooling or equipment to install properly.

There exists a need for a decorative ornament for light fixture that is easy to install and remove without use of complicated tooling and/or risk of damaging the surface to which it is connected. Also, there is a need for a decorative ornament that is relatively inexpensive for the average consumer to purchase. Further, there is a need for a decorative ornament that does not require knowledge or need of electrical manipulation with a light fixture.

### SUMMARY OF THE INVENTION

In one aspect, the present invention provides a decorative ornament. The decorative ornament may include any number of different materials and components sufficient to achieve a desired aesthetic effect when installed at or near a light source of a home or business interior or exterior.

In another aspect, the present invention provides an easily removable decorative ornament.

In yet another aspect, the present invention provides an inexpensive method of decorating an interior or exterior of a home or business.

In yet another aspect, the present invention provides a decorative ornament that is easy to install.

In yet another aspect, the present invention provides a decorative ornament for a light fixture that requires no electrical work or need to alter a light fixture whatsoever.

### BRIEF DESCRIPTION OF THE DRAWINGS

FIG. 1 is a perspective side view of one embodiment of a decorative ornament in accordance with the present invention.

FIG. 2 is a perspective top view of the decorative ornament shown in FIG. 1.

FIG. 3 is a perspective side view of another embodiment of a decorative ornament in accordance with the present invention.

FIG. 4 is a perspective bottom view of the decorative ornament shown in FIG. 3.

FIG. 5 is a perspective side view of another embodiment of a decorative ornament in accordance with the present invention.

FIG. 6 is a perspective top view of the decorative ornament shown in FIG. 5.

FIG. 7 is a perspective side view of another embodiment of a decorative ornament in accordance with the present invention.

FIG. 8 is a perspective top view of the decorative ornament shown in FIG. 7.

FIG. 9 is a perspective side view of one embodiment of an assembly used to attach a decorative ornament to a light fixture in accordance with the present invention.

FIG. 10 is a perspective side view of another embodiment of an assembly used to attach a decorative ornament to a light fixture in accordance with the present invention.

FIG. 11 is a perspective side view of another embodiment of a decorative ornament in accordance with the present invention.

FIG. 12 is a perspective side view of another embodiment of a decorative ornament in accordance with the present invention.

FIG. 13 is a photograph of another embodiment of a decorative ornament in accordance with the present invention.

FIG. 14 is a photograph of another embodiment of a decorative ornament in accordance with the present invention.

FIG. 15 is a photograph of another embodiment of a decorative ornament in accordance with the present invention.

FIG. 16 is a photograph of another embodiment of a decorative ornament in accordance with the present invention.

FIG. 17 is a perspective side view of another embodiment of a decorative ornament in accordance with the present invention.

FIG. 18 is a perspective side view of another embodiment of a decorative ornament in accordance with the present invention.

FIG. 19a is a perspective side view of another embodiment of a decorative ornament in accordance with the present invention.

FIG. 19b is a sectional side view of the embodiment of the decorative ornament shown in FIG. 19a.

FIG. 20 is a perspective side view of another embodiment of a decorative ornament in accordance with the present invention.

### DETAILED DESCRIPTION OF THE INVENTION

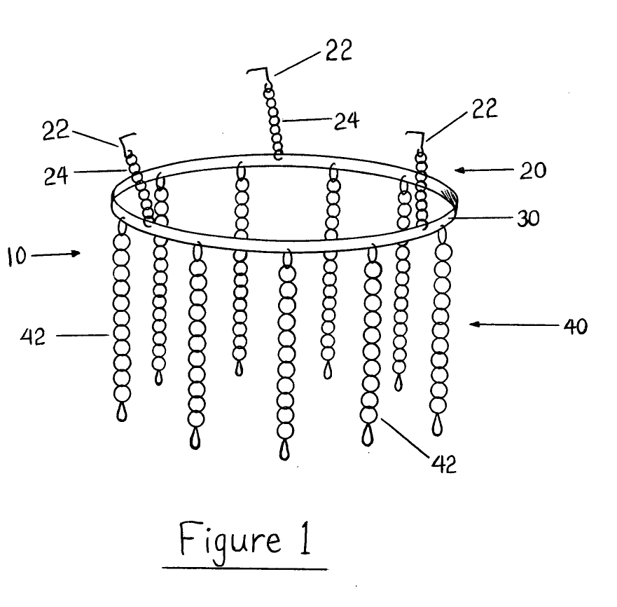

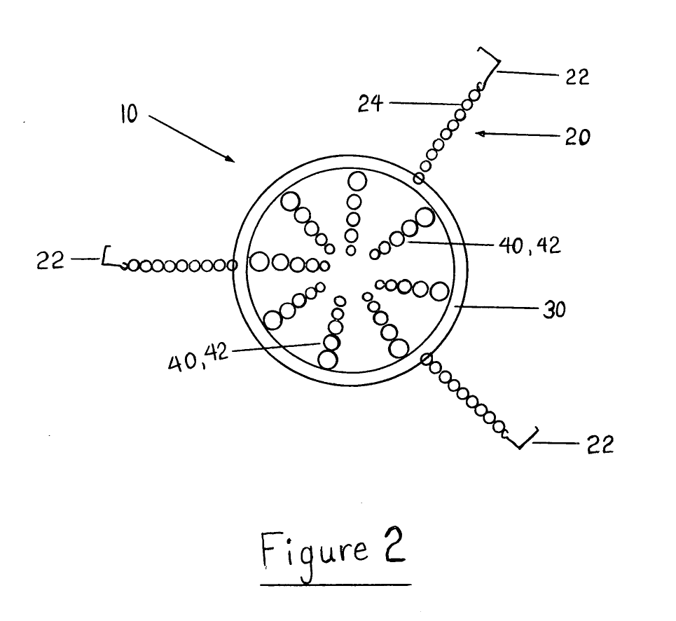

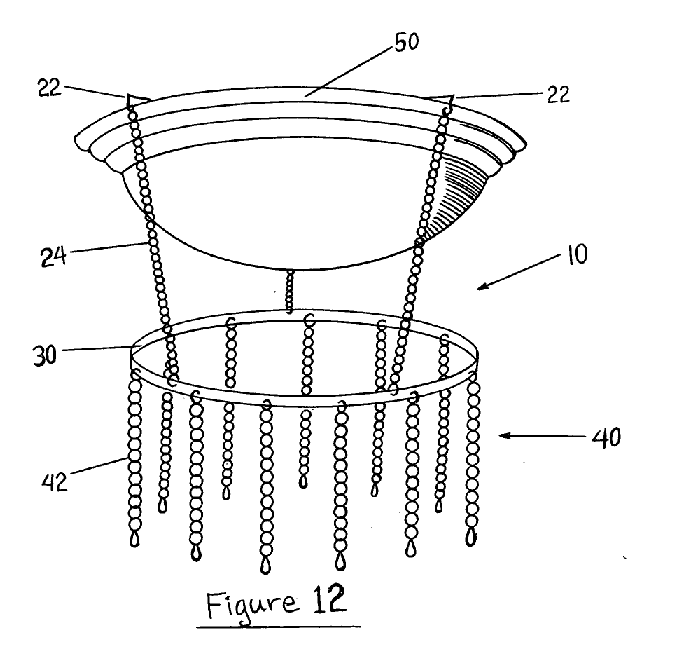

FIGS. 1, 2 and 12 show a decorative ornament 10 according to one embodiment of the present invention. The decorative ornament 10 generally include at least one anchor portion 20, at least one support portion 30 and a least one decorative portion 40. More specifically, the embodiment illustrated in FIGS. 1 and 2 indicates three anchor portions 20 having hook 22 and chain 24 assemblies, the anchor portion 20 being positioned approximately equilaterally from one another (although other orientations are contemplated herein), in operable connection with a light fixture (not shown in FIGS. 1 and 2; shown in FIG. 12) and a support portion 30. The decorative portion 40, as shown in FIGS. 1, 2 and 12, includes a plurality of beaded string assemblies 42 affixed hangingly from a support portion 30.

An anchor portion 20 may include any number of materials, designs, shapes and lengths that would serve to secure a decorative ornament 10 to a light fixture (not shown in FIGS. 1 and 2; shown in FIG. 12) or a surface at or near a light fixture of a home or office exterior or interior (not shown), including but not limited to hooks, clips and other fasteners. Accordingly, an anchor portion 20 may include a variety of shapes and sizes, including but not limited to L-shaped, U-shaped, arcuate, paper clip-type configurations and other similar shapes that one of ordinary skill in the art would contemplate for use in accordance with the present invention. An anchor portion 20 may include a variety of materials, including but not limited to, plastic, metal, wood, glass, nylon, elastic and any combination thereof. An anchor portion 20 further may include any predetermined length selected to achieve a desired aesthetic and physical result. Most preferably, the anchor portion 20 is comprised of material that is heat- and/or flame-resistant or, at a minimum, heat-tolerant.

A support portion 30 may include any number of materials and designs that would serve to support a decorative portion 40 of a decorative ornament 10, while also providing an operable connection with at least one anchor portion 20. A support portion 30 may include any number of materials and shapes. The types of materials contemplated for use in a support portion 30 would include, but are not limited to, different types of metals (for example, various gauges of wire, rings, etc), plastics, wood, glass, nylon and elastic, as well as any number of combinations thereof.

The types of shapes contemplated for use in a support portion 30 would include, but are not limited to, rings, circles, squares, rectangles, ellipses, whether such shape (and/or material) is contiguous or non-contiguous and/or such shape is occupying one dimensional plane or multi-dimensional planes, in orientation. Preferably, a support portion 30 is constructed of materials (for example, rigid plastic), shapes, or a combination thereof, such that a predetermined weight of a decorative portion 40 is provided adequate support to achieve a desired aesthetic effect of an installed decorative ornament 10. Most preferably, a support portion 30 is comprised of material that is heat- and/or flame-resistant or, at a minimum, heat-tolerant.

A decorative portion 40 may include any number of materials and designs that would serve to provide a desired aesthetic effect of a decorative ornament 10. Such designs of the decorative portion 40 may further include numerous patterns and orientations, whether predetermined or customized, as desired by the consumer. The decorative portion 40 may include beading, chains, ribbons, strings, wires and any combination thereof (each of various possible shapes, sizes and materials), of any desired predetermined length contemplated by one of ordinary skill in the art, selected to achieve a desired aesthetic or physical result. Materials contemplated for use in the decorative portion 40 may include, but are not limited to, glass, wood, metals, fabric, nylon, plastic, paper and other materials that are known by ordinary persons of skill in the art. Most preferably, a decorative portion 40 is comprised of material that is heat- and/or flame-resistant or, at a minimum, heat-tolerant.

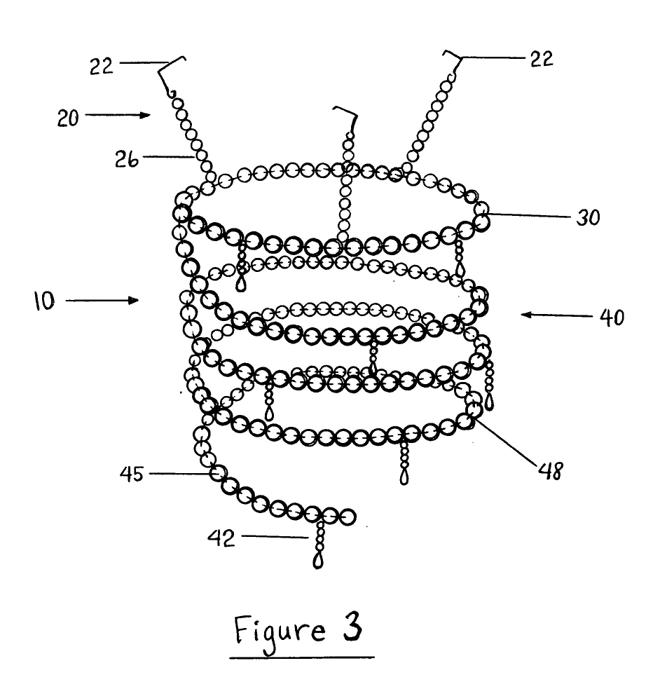

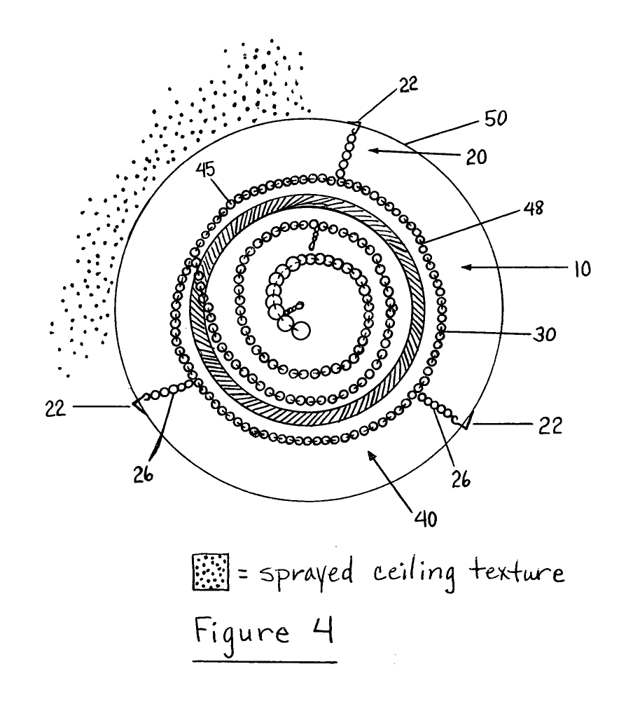

FIGS. 3 and 4 illustrate a decorative ornament 10 according to another embodiment of the present invention, including three anchor portions 20, removably connected with a light fixture 50, and also operably connected with a substantially combined support portion 30 and decorative portion 40. More specifically, the decorative ornament 10 includes three anchor portions 20 having three separate hook 22 and beaded string 26 assemblies, operably connected with the substantially combined support portion 30 and decorative portion 40. Additionally, the combined support portion 30 and decorative portion 40 include a substantially planar support portion 30 which is operably connected with a helical or spring-like decorative portion 40, the decorative portion 40 including a foundation of memory wire 48 threaded through decorative beads 45 (as well as optionally affixed additional decorative beaded strings 42, as shown) and formed into a desired overall shape.

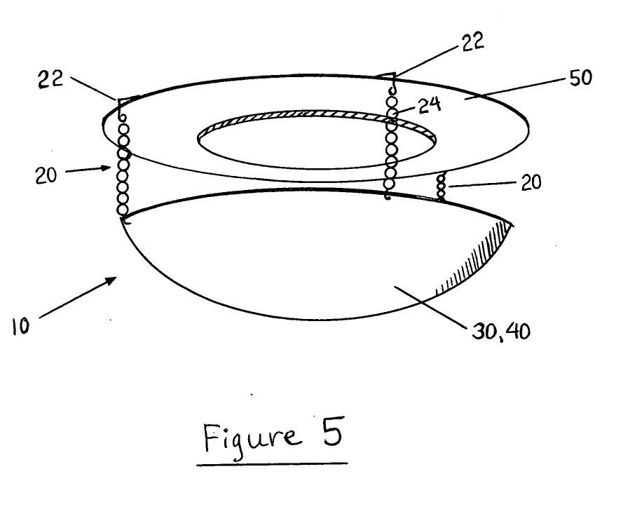

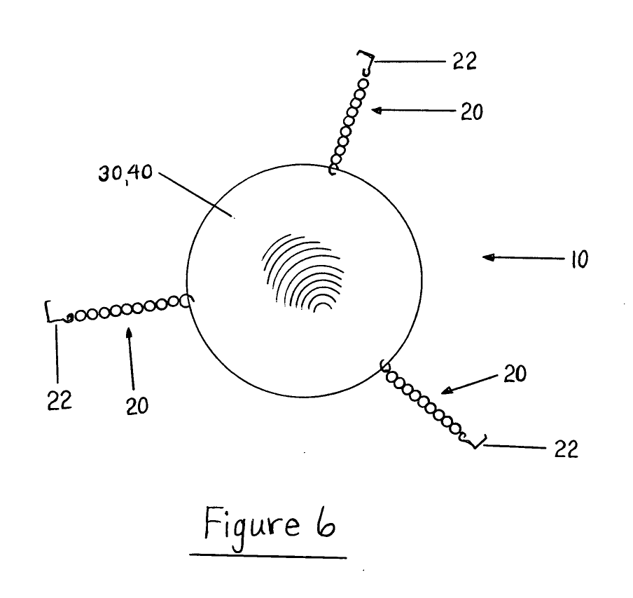

FIGS. 5 and 6 illustrate a decorative ornament 10 according to another embodiment of the present invention, including three anchor portions 20, removably connected with a light fixture 50, and also operably connected with a substantially combined support portion 30 and decorative portion 40. More specifically, the decorative ornament includes three anchor portions 20 having three separate hook 22 and chain 24 assemblies, operably connected with the substantially combined support portion 30 and decorative portion 40, in the form of a substantially bowl shape, all of which produces a desired decorative and lighting effect.

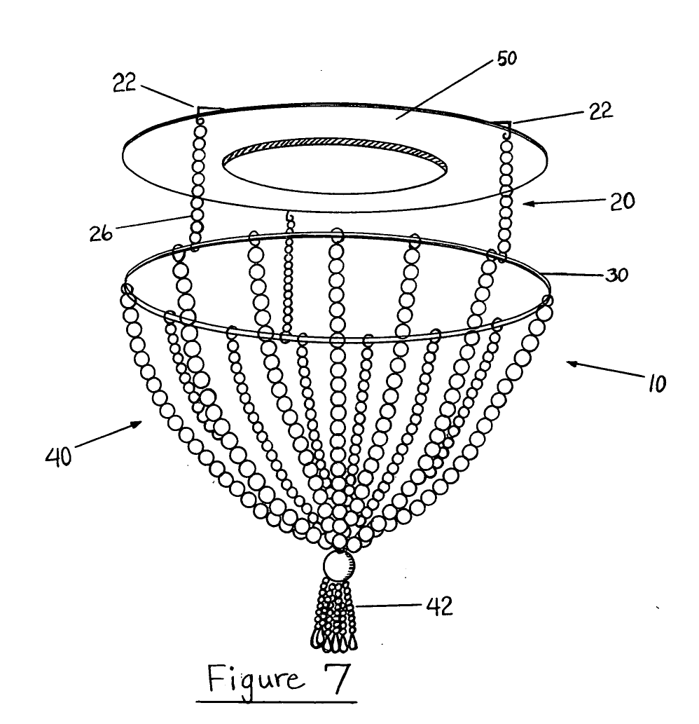

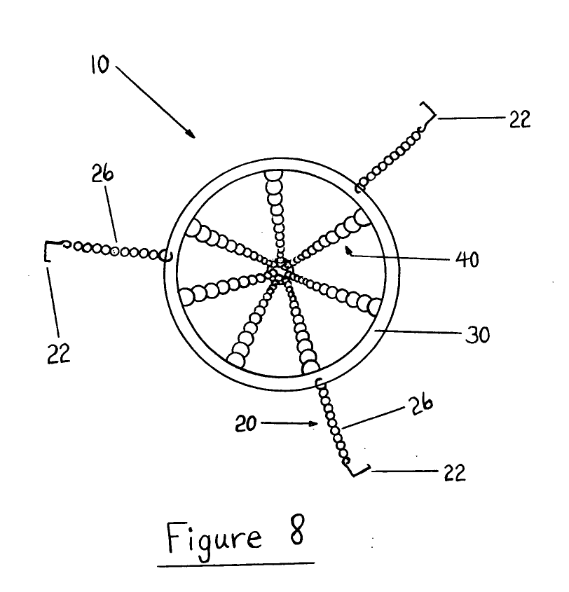

FIGS. 7 and 8 illustrate a decorative ornament 10 according to another embodiment of the present invention, including three anchor portions 20, a support portion 30 and decorative portion 40. More specifically, the decorative ornament 10 includes three anchor portions 20 having three separate hook 22 and beaded string 26 assemblies, operably connected with a support portion 30 including a rigid material ring, which is operably connected with a decorative portion 40 including numerous beaded string assemblies that are gathered at a predetermined region along the length of the strings assemblies, to produce a desired aesthetic effect.

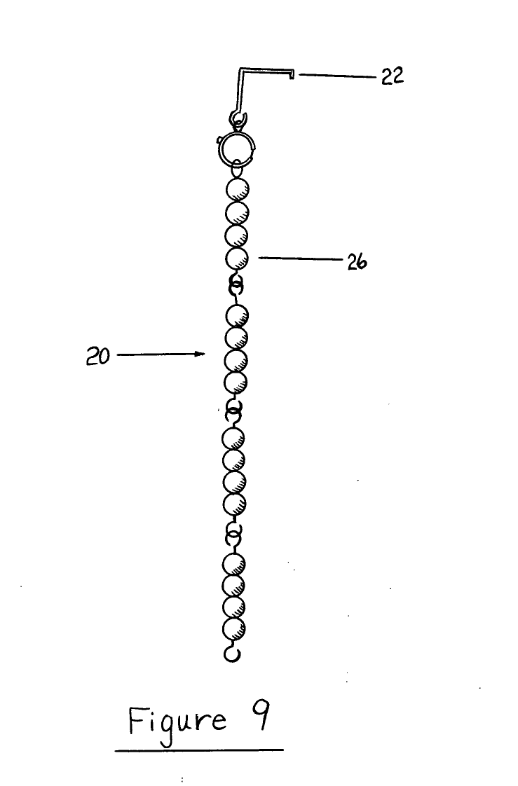

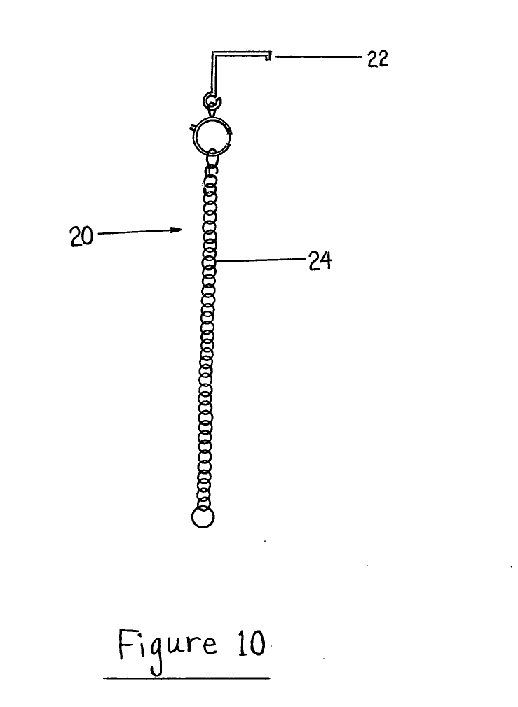

FIGS. 9 and 10 illustrate two different embodiments of anchor portions 20 contemplated for use with the present invention. Namely, FIG. 9 illustrates one embodiment of a hook 22 and beaded string 26 assembly contemplated for use as an anchor portion 20 as described herein. FIG. 10 illustrates one embodiment of a hook 22 and chain 24 assembly as contemplated for use as an anchor portion 20 as described herein.

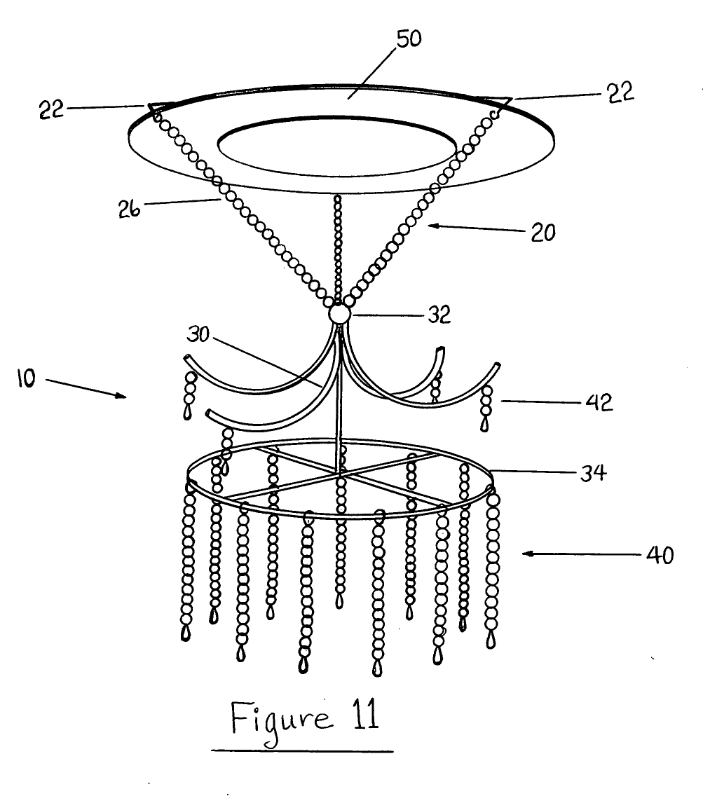

FIG. 11 illustrates a decorative ornament 10 according to another embodiment of the present invention, including three anchor portions 20, a support portion 30 and decorative portion 40. More specifically, the decorative ornament 10 includes three anchor portions 20 having three separate hook 22 and beaded string 26 assemblies, and a substantially combined support portion 30 and decorative portion 40. The combined support portion 30 and decorative portion 40 include a support portion 30 which is operably connected with the anchor portions 20 by a first support ring 32 placed in a substantially perpendicular orientation relative to a light fixture 50 and a second support ring 34 placed in a substantially parallel orientation relative to a light fixture 50, and decorative portions 40 operably connected with the above-described support portions 32, 34.

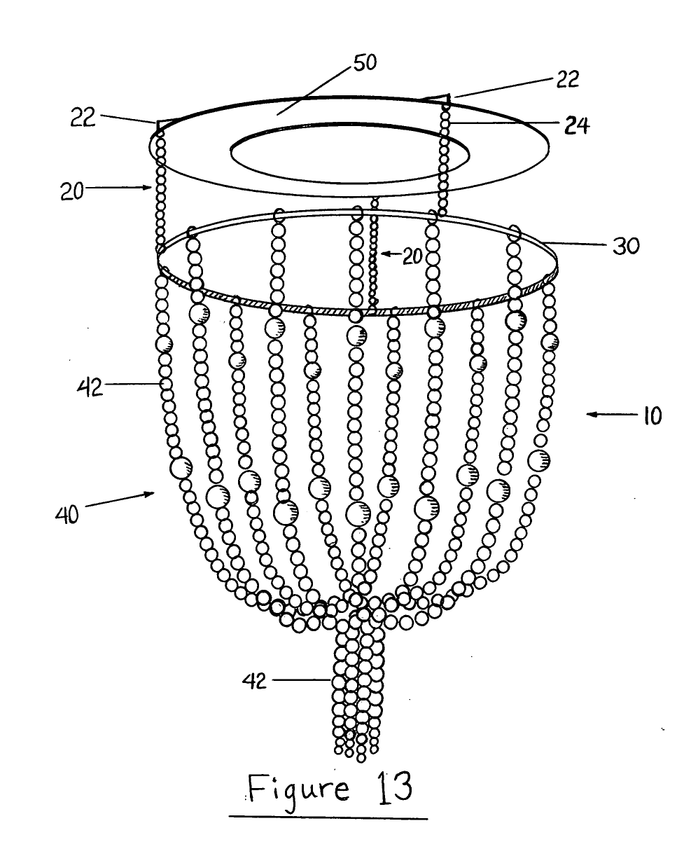

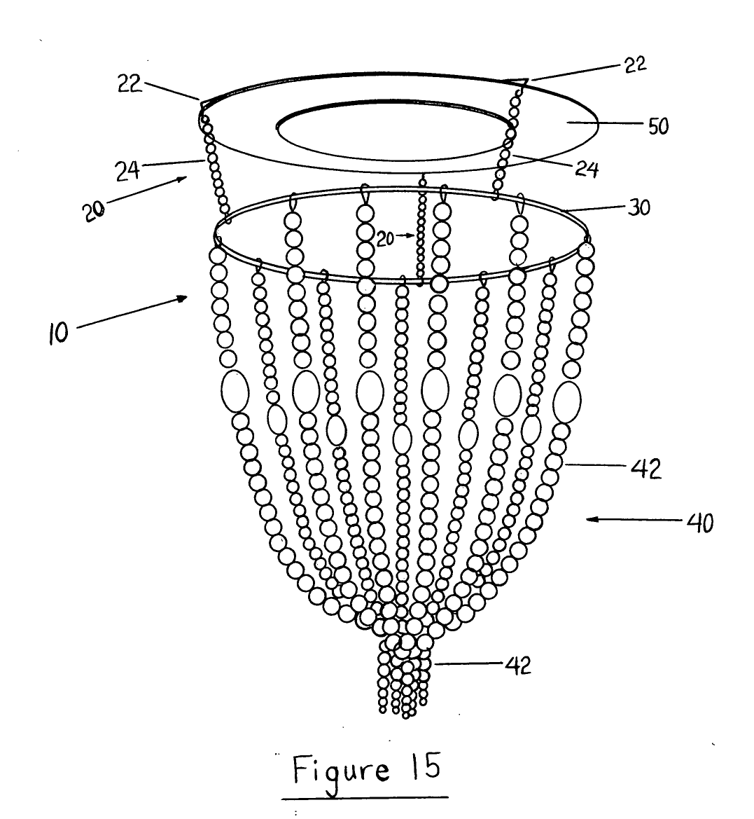

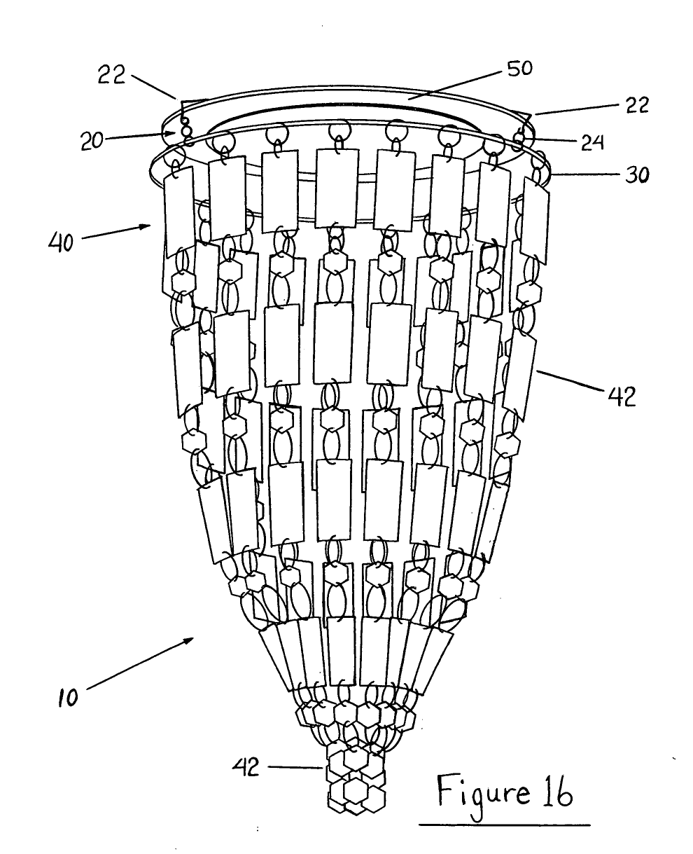

FIGS. 13, 15 and 16 illustrate decorative ornaments 10 according to another embodiment of the present invention, including (each) three anchor portions 20, a support portion 30 and decorative portion 40. More specifically, the decorative ornaments 10 includes three anchor portions 20 having three separate hook 22 and chain 24 assemblies, operably connected concurrently with a surface of a light fixture 50 and a support portion 30 including a rigid material ring, which is operably connected with a decorative portion 40 including numerous beaded string assemblies 42 that are gathered at a predetermined regions along the lengths of the beaded strings assemblies 42 (respectively), to produce desired aesthetic effects.

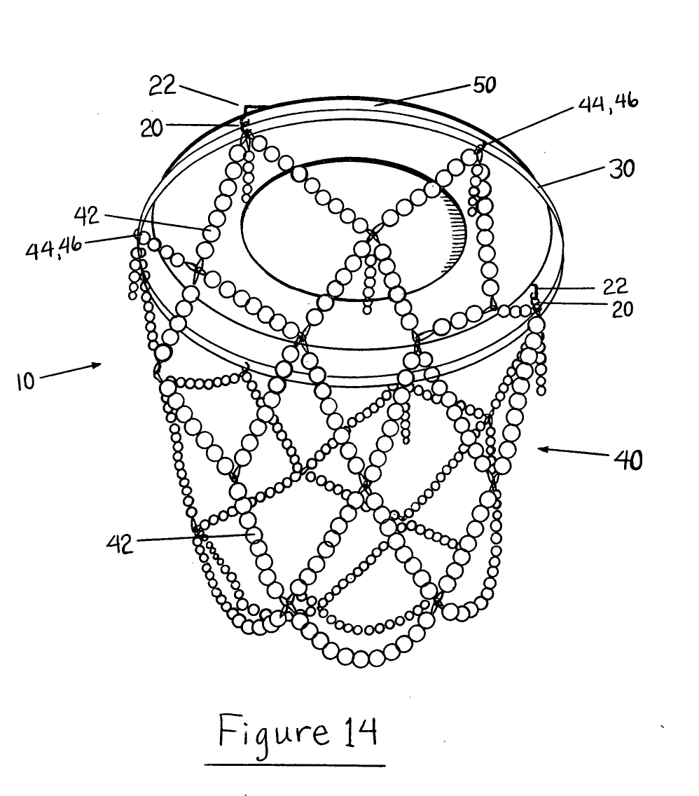

FIG. 14 illustrates a decorative ornament 10 according to another embodiment of the present invention, including three anchor portions 20, a support portion 30 and decorative portion 40. More specifically, the decorative ornaments 10 includes three anchor portions 20 having three separate hooks 22, operably connected with a support portion 30 including a rigid material ring, which is operably connected with a decorative portion 40 which is operably connected with the support portion 30 by first attachment rings 44 at numerous predetermined locations along the support portion 30 and, further, by second attachment rings 46 connected with the first attachment rings 44 and supporting gathered beaded string assemblies 42, to produce a desired aesthetic effect.

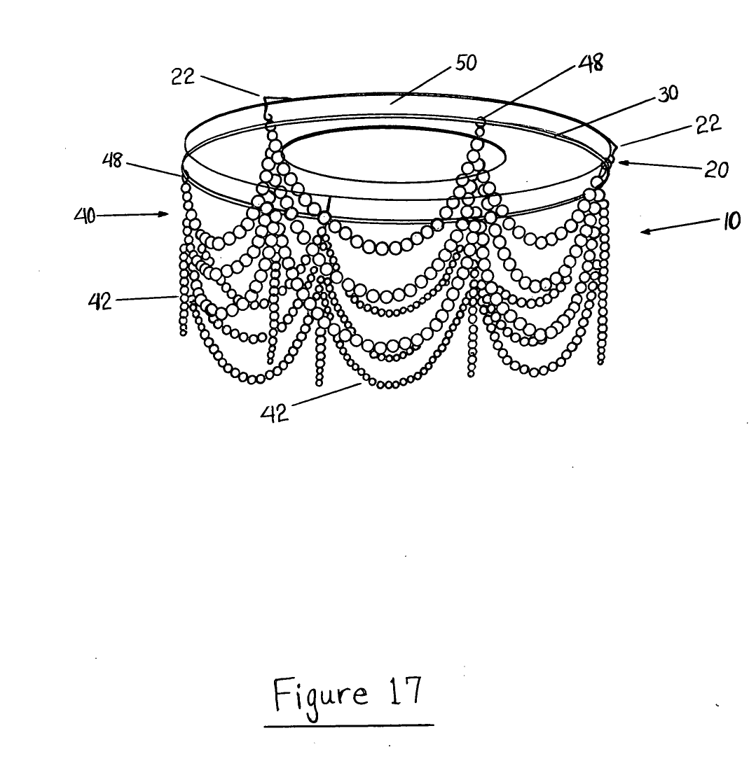

FIG. 17 illustrates a decorative ornament 10 according to another embodiment of the present invention, including three anchor portions 20, a support portion 30 and a decorative portion 40. More specifically, the decorative ornaments 10 includes three anchor portions 20 having three separate hooks 22, operably connected with a support portion 30 including a rigid material ring, which is operably connected with a decorative portion 40. The decorative portion 40 is operably connected with the support portion 30 at numerous predetermined locations along the support portion 30 as shown and, further, the decorative portion 40 is connected by rings 48 supporting beaded string assemblies 42 that are interconnected at predetermined regions along the lengths of the beaded string assemblies 42, to produce a desired aesthetic effect.

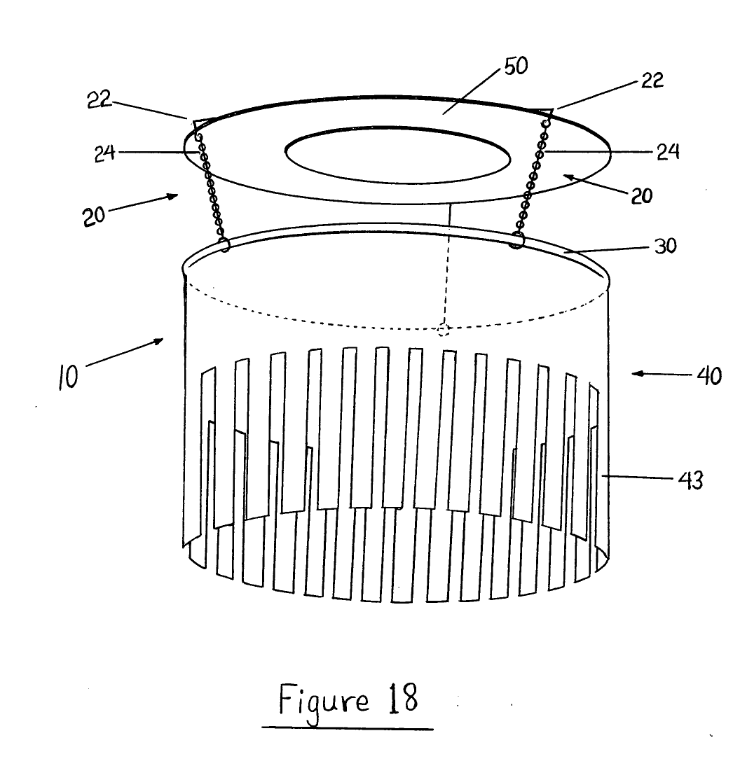

FIG. 18 illustrates a decorative ornament 10 according to another embodiment of the present invention, including two anchor portions 20 removably connected with a light fixture 50, and also operably connected with a substantially combined support portion 30 and decorative portion 40. More specifically, the decorative ornament includes two anchor portions 20 having hook 22 and chain 24 assemblies, operably connected with the substantially combined support portion 30 and decorative portion 40, in the form of a substantially cylindrical-shaped plastic piece and having a plurality of plastic strips 43 hangingly affixed thereon, all of which produces a desired decorative and lighting effect.

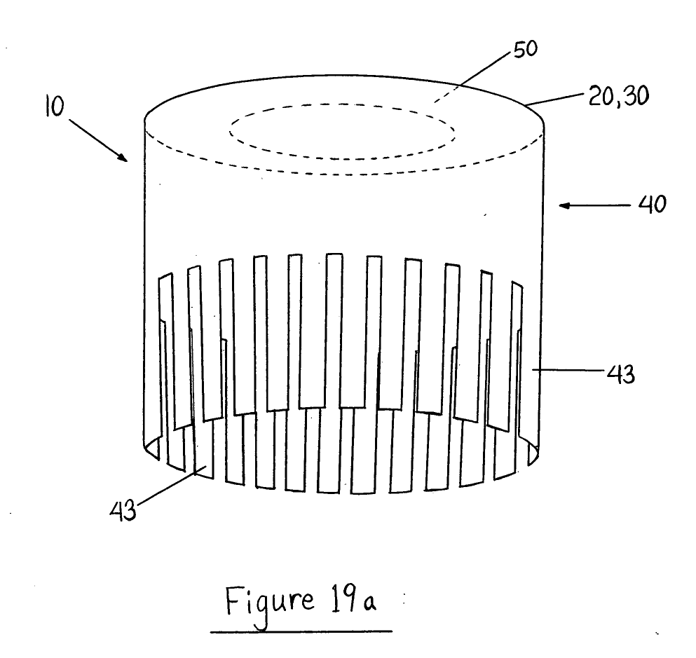

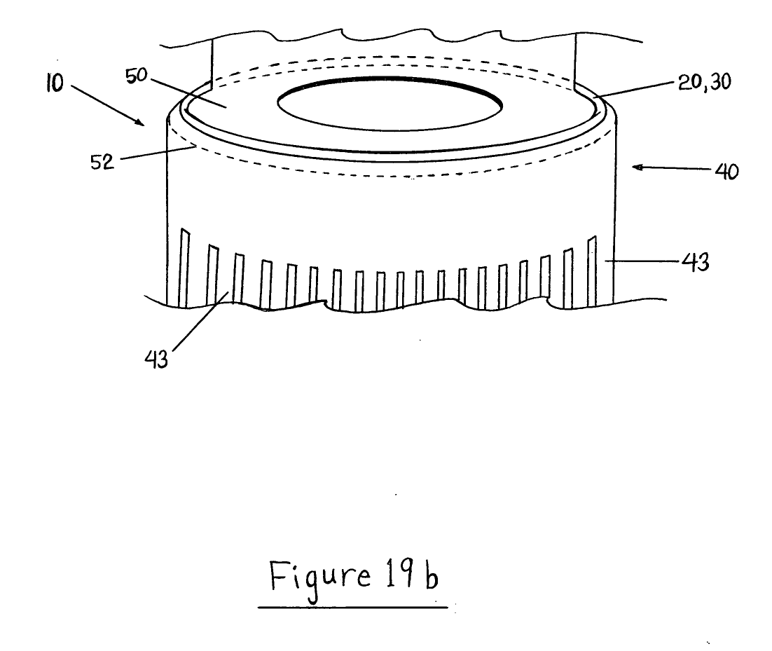

FIG. 19a illustrates a decorative ornament 10 according to another embodiment of the present invention, including a substantially combined anchor portion 20 and support portion 30, removably connected with a light fixture 50, and also operably connected with a decorative portion 40. As illustrated in FIG. 19b, the decorative ornament 10 includes a substantially combined anchor portion 20 and support portion 30 is removably affixed at or about a light fixture 50 at its rim 52, which is also operably connected with a decorative portion 40. The decorative portion 40 includes the form of a substantially cylindrical-shaped plastic piece and further includes a plurality of plastic strips 43 hangingly affixed thereon, all of which produces a desired decorative and lighting effect.

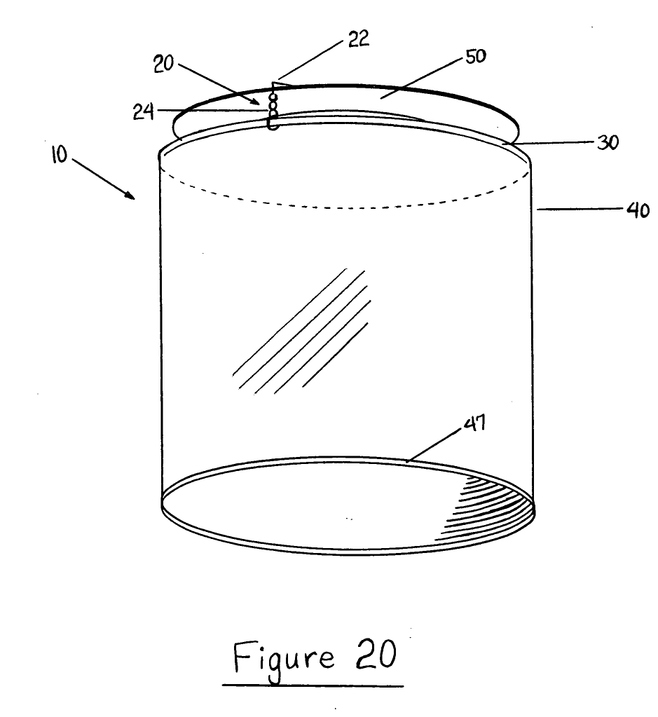

FIG. 20 illustrates a decorative ornament 10 according to another embodiment of the present invention, including three anchor portions 20 removably connected with a light fixture 50, and also operably connected with a substantially combined support portion 30 and decorative portion 40. More specifically, the decorative ornaments 10 includes three anchor portions 20 (only one is shown) having three separate hook 22 and chain 24 assemblies, operably connected with a substantially combined support portion 30 including a rigid material ring, which is operably connected with a decorative portion 40. The decorative portion 40 includes a substantially cylindrical, substantially translucent fabric material (for example, nylon) operably connected with a weighted ring 47 of predetermined shape and material (as earlier described herein) sufficient to hold the decorative portion 40 at a predetermined position and length, sufficient to produce a desired aesthetic effect.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A decorative ornament, comprising:
at least one support portion;
at least one anchor portion; and
at least one decorative portion
wherein said at least one anchor portion is removably connected with at least a portion of a light fixture and said at least one support portion is operably connected between said at least one anchoring portion and said at least one decorative portion.

2. The decorative ornament of claim 1 wherein said at least one anchor portion comprises at least one L-shaped hook.

3. The decorative ornament of claim 1 wherein said decorative ornament is suspendable from a can ceiling light.

4. The decorative ornament of claim 1 wherein said at least one decorative portion comprises a plurality of decorative strings.

5. The decorative ornament of claim 1 wherein said at least one support ring is comprised of a rigid, plastic material.

6. The decorative ornament of claim 1 wherein said at least one anchor portion comprises a hook and chain assembly.

7. The decorative ornament of claim 4 wherein said plurality of decorative strings further comprises a helically-shaped memory wire having beads threaded therethrough.

8. The decorative ornament of claim 1 wherein said at least one decorative portion comprises a substantially transparent bowl shape.

9. The decorative ornament of claim 1 wherein said at least one decorative portion comprises plastic having a cylinder shape and a plurality of strips operably connected therewith.

10. The decorative ornament of claim 9 wherein said at least one anchor portion and said at least one support ring are substantially combined.

11. The decorative ornament of claim 10 wherein said substantially combined at least one anchor portion and at least one support ring are comprised of elastomeric material positioned at or around an edge of a can light fixture.

12. A decorative ornament for a light fixture, comprising:
a rigid support portion;
an least two anchor portions; and
a plurality of beaded strings;
wherein said support ring is operably connected with said anchoring portion, said anchoring portion being affixed to said light fixture, and said plurality of beaded strings being suspended from at least one portion of said support ring.

13. The decorative ornament of claim 12 wherein said plurality of beaded strings comprises a predetermined pattern of interconnected wires with beads threaded therethrough.

14. The decorative ornament of claim 12 wherein said at least two anchor portions comprise three hook and bead assemblies.

15. The decorative ornament of claim 12 wherein said plurality of beaded strings comprise light-reflecting beads.

16. A method of decoration, comprising the steps of:
providing a light fixture;
affixing a decorative ornament at or near a location supporting said light fixture; and
illuminating said decorative ornament with said light fixture.

17. The method of claim 16 wherein affixing a decorative ornament at or near a location supporting said light fixture comprises removably affixing a decorative ornament.

18. The method of claim 16 wherein providing a light fixture comprises providing a dome light.

19. The method of claim 16 wherein affixing a decorative ornament at or near a location supporting said light fixture comprises affixing a decorative ornament to an outer edge of a can ceiling light.

20. The method of claim 16 wherein affixing a decorative ornament to an outer edge of a can ceiling light comprises affixing a decorative ornament at a predetermined distance from said light fixture, to achieve a predetermined illumination effect.
